(19) United States
(12) Patent Application Publication
(10) Pub. No.: US 2002/0072996 A1
(43) Pub. Date: Jun. 13, 2002

(54) Method of and apparatus for practicing religious faith through the world wide web via purchase of copies of proprietary religious audio and visual works and merchandise

(76) Inventor: Richard S. Paiz, North Miami Beach, FL (US)

Correspondence Address: GLENN GOLD, P.A., 1503 Silverleaf Oak Court, Palm Beach Gardens, FL, 33410, US

(21) Appl. No.: 09/819,177

(22) Filed: Mar. 27, 2001

Related U.S. Application Data
(60) Provisional application No. 60/193,160, filed on Mar. 28, 2000.

(51) Int. Cl. G06F 17/60

(52) U.S. Cl. 705/27; 705/26

(57) ABSTRACT

A computer network system within a virtual environment for delivery of religious works of authorship to subscribing members of a church in exchange for payment includes a number of computers which are networked to each other in a hierarchy to function as a single unit, the hierarchy including a first tier including at least one parent computer performing subscribing member billing tasks and synchronizing and delegating tasks among the number of computers, a second tier including at least one server computer allocating network resources to maximize bandwidth and direct selected works to subscribing members requesting the works; and a third tier including a number of subscribing member computers, each subscribing member computer having system programming containing individual subscribing member identification program and work accessing program. The work accessing program preferably includes a virtual reality representation of a site and an interactive accessing procedure. The site is optionally a house of worship. The interactive accessing procedure preferably includes interacting with one of: a virtual priest and a virtual representation of Our Lord Jesus Christ.

### BACKGROUND OF THE INVENTION

1. Field of the Invention:

The present invention relates generally to the field of distribution of religious merchandise and musical and video works to members of the faith entity, which for purposes of example only is referred to in the paragraphs which follow as the Roman Catholic Church or other established Church entity. More specifically the present invention relates to a method of and apparatus for controlled delivery of religious proprietary sound recordings and moving pictures by a Church entity to its world-wide faith community via computer terminals, either through playing compact disks, or other physical data storage media, or through accessing the World Wide Web (hereinafter the Web) in such a way that Church member access is controlled and the Roman Catholic Church and its world wide community receive the appropriate contributions, profits, and royalties legally due to them for playing each religious song, music video, virtual Church activity, or movie by a subscribing Church member (hereinafter referred to as a subscribing member or subscriber).

2. Description of the Prior Art:

There have long been religious services performed in physical Church buildings and sales of Church related merchandise items. Yet these services and items are not always readily accessible and may require substantial effort in gaining transportation to reach their physical sources. The elderly and persons living in remote and isolated areas of the world may have difficulty participating in the activities of the Church. For the Bible says that:

“Everyone who asks receives; the one who seeks, finds; and to the one who knocks the door will be opened.”(Matt 7:8)

On a larger scale, church members often have work and family demands on their time which make regular Church attendance difficult and thus miss the opportunity to practice their faith.

It is thus an object of the present invention to provide a system and method of delivering proprietary musical and moving picture works owned by the Church to subscribing church members in exchange for payment, with appropriate royalties and advertising revenues being directed to the Church.

It is another object of the present invention to provide such a system and method which provide enhanced access to musical presentations, and Church activates to church members, and which personalizes offers of works and merchandise to individual members.

It is still another object of the present invention to provide such a system and method which provide means for ordering, paying for and arranging delivery of tangible church merchandise, and which improve quantity and quality of merchandise available to members.

It is finally an object of the present invention to provide such a system and method which permit complete control of access and interaction by the Church, both at the local level such as the parish and from the highest level such as the Vatican, to conform its membership to conduct consistent with the teachings of the Church. For it is written:

“repay to Caesar what belongs to Caesar and to God what belongs to God. (Matthew 22:21). At the same time, the first and greatest commandment is to:

“Love the Lord, your God, with all your heart, soul and mind.” (Matt 22:37).

### SUMMARY OF THE INVENTION

The present invention accomplishes the above-stated objectives, as well as others, as may be determined by a fair reading and interpretation of the entire specification.

A method is provided for supplying merchandise to members while optimizing the distribution channels to maximize profitability and improve customer service, increasing the quantity and quality of merchandise available to members, personalizing offers to individual members, signing up more e-merchants including secular entities selling Church merchandise, and advertisers is provided to bring higher contributions and profit revenue for purchases made directly by each member in the physical Church or through the Web.

A method for delivering audio and audio visual works to users of computer terminals is also provided, including the steps of: providing a data warehouse of digitized works; providing program means for subscribing members computers to access, select and play works such as to participate as part of a virtual Church activity; and providing means for controlling contributions to the Church, payment for works played and advertising displayed to each member. The method preferably includes the additional steps of encrypting the works. The method can also include the still additional steps of delivering advertising matter to the subscribing member when a member chooses to participate in a Church activity, or when a member selects and plays each work; keeping a record of the particular activity and works the individual member selects and plays; and customizing advertising delivered to the subscribing member to fit within any pattern of work selection by the particular member.

An apparatus for performing the method is also provided, including a computer hive made up of a plurality of inter-linked computer devices having specialized functions, the computers operating in unison to function as a supercomputer having shared disk space and memory, in which each node belongs to the collective and possesses its own business rules and membership to a computer network organization managerial hierarchy. The computer hive preferably includes multiple tiers of computer clusters: a software tier in which each subscribing member has his or her own member identification number which is unique and which belongs to a specific parish; an IP tier in which several IP servers allocate resources to subscribing members so that they can interact in the virtual environment; a billing and control tier through which the computer hive validates each member request, performs live billing, and controls all of the interaction the members receive; an Internal TQM and Security Tier, through which the supplier regulates delivered content according to the member agreement and local, state, federal or national, and international law in real time to improve the quality, product and service delivered to the members and a summit tier through which a virtual representation of God is created which includes a database containing data about world history, dilemmas, customs, contemporary beliefs and dogma. The system also regulates and gives access to law enforcement agencies and internal church security to monitor, manage and control access by and privileges of members to bring law and order where the Web has created anarchy and chaos. For Acts 2:4, 6 says: “they began to speak in different tongues, but each one heard them speaking in his own language.” (Paraphrased).

The billing and control tiers are locally and regionally geographically distributed to maximize bandwidth and better adapt to the needs of the Church member. Each IP server belongs to a specific archdioceses, and preferably hosts all of its members. These blocks of members receive live video from a virtual priest and/or individualized selections from a virtual angel, such as St. Michael and are permitted specific and approved interaction with a virtual interpretation of our Lord Jesus Christ (hereinafter called Virtual Jesus).

For he is the Good Shepard. The sheep hear his voice, as he calls them by name and leads them . (John 10:3) Paraphrased

The billing and control tier is also responsible for providing on demand resources to each subscribing member.

The apparatus includes a data warehouse for logistics, planning, and provisioning to facilitate the distribution of merchandise in the form of tangible items which cannot be sent through the computer, such as crosses and T-shirts, to members via the religious article store of their local parish.

In order to become a subscribing member, one must first be a valid parishioner of a specific Roman Catholic Church or another Church. Each member may only belong to one parish at a specific time. The prospective member must go to the corresponding rectory and apply in person to a bona fide Church official. Preferably, the Church will request from the parishioner various key documents set forth specifically in the Detailed Description. Once these requests are satisfied the subscribing member is permitted to purchase subscriber software which gives the member access to the Web-based virtual reality Roman Catholic Church Community, hereinafter referred to as the Church.

The data warehouse of Church-specific religious merchandise, digitized music and video works is created and placed on a physical data storage medium, such as a compact disk; in a transferable computer file on the Web, or in a physical Church facility. The subscribing member pays a periodic subscription fee to the supplier, and pays for each merchandise item and work that they purchase, and designates that all or a portion be contributed to any valid Church organization of the member choice.

The local parish pastor upon approving a member to the Web organization suppLies personal information of members and their families necessary for use in marketing, securing a credit card or debit card number for use in member billing. Contributions to the Church are collected and distributed among the institutions: (1) Parish (local); (2) Archdioceses (regional); and (3) Vatican Pastoral Council (worldwide). The parish in which the member is registered in the supplier's system determines which Parish and Archdioceses receives the contributions or revenues when a financial transaction is performed.

All the paid merchandise, audio and musical works profits are also appropriated to the Church in the form of contributions. The supplier of the works and merchandise may be the Church itself or an authorized distributor and it optionally gains additional revenues through the delivery of advertising segments on subscriber member computer speakers or computer monitors, as applicable and these advertisements preferably run prior to playing of works or selling of merchandise. The Church is able to promote its own local, regional and worldwide institutions. For example, each Parish may have an introduction video clip for each new member welcoming and thanking him or her for participating with the Church via the Web.

The selection of works and merchandise by each member are recorded and stored for marketing and internal Total Quality Management (TQM) to understand what the members value, and how the Church can improve their spiritual experience. This information is used in part to customize the advertising displayed for the particular member during the purchasing of merchandise, playing of specific works, and during the execution of financial transactions.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a block diagram of the entire computer system made up of a number of networks representing individual faith communities and their members;

FIG. 2 is a schematic view or block diagram of the computer hive constructed to execute the inventive method of proprietary religious work delivery to subscribing church members. In the example, the first tier is grouped by individual faith communities collectively making up the church, such as parishes, the second tier is grouped by types of activities such as church services and the third tier is grouped by advertiser or commercial sponsor. The third tier does data mining, actual advertising and editing;

FIG. 3 is a schematic representation of the payment methods leading to playing of music or a moving picture, and how the payment is divided. If payment is in cash, the payment is divided between the Church, at any of the various Church hierarchy levels, and any authorized outside supplier. If payment is made by credits accumulated through receiving advertisements, payment is made to the church with corporate sponsors funds;

FIG. 4 is a schematic representation of system structure, showing the role of virtual environment in financial transactions, advertisement patterns and music or moving picture use. The present system uses a virtual reality engine but the genesis engine synchronizes all of the operations;

FIG. 5 is a further schematic of system structure, showing connections made or music and moving picture selections;

FIG. 6 is a block diagram of how questions posed to the virtual representation of God are received, categorized and answered. The core foundation, illustrated in this diagram, is in essence the laws of God and is the basis of the decision making and evaluation of each request and response. The lay priests are active participants and give their own interpretations based upon their own personal experience of the problem or question asked.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various figures are designated by the same reference numerals.

### First Preferred Embodiment

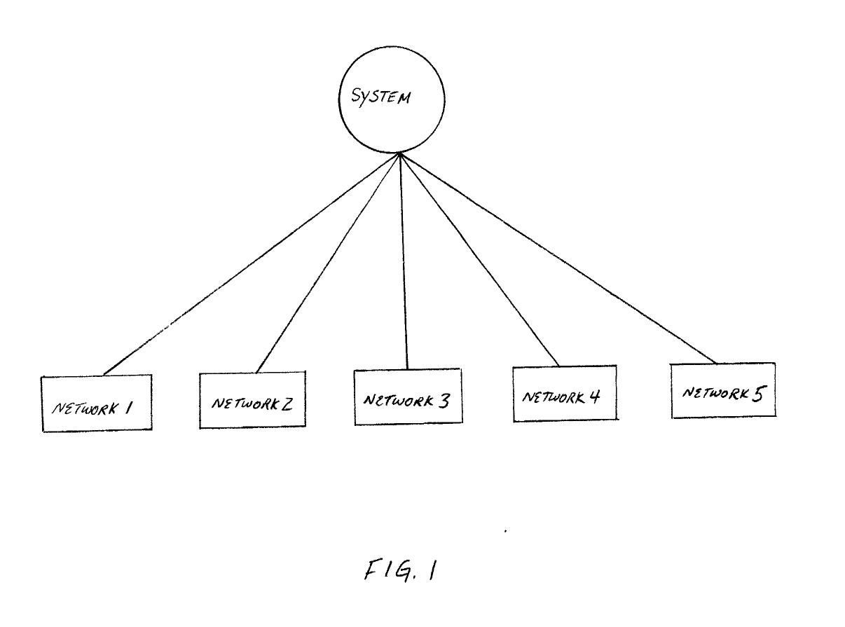

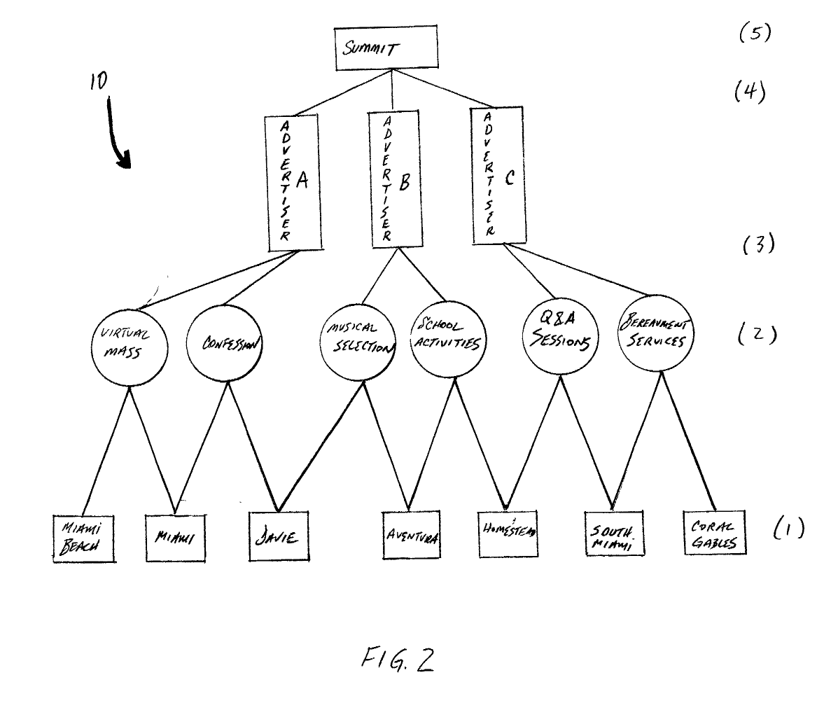

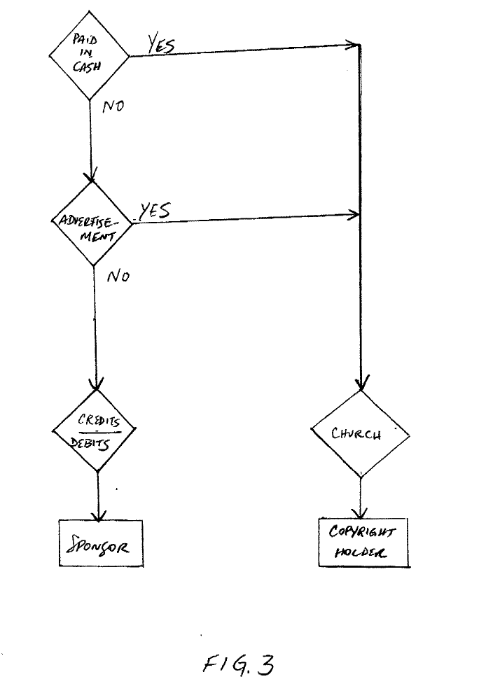

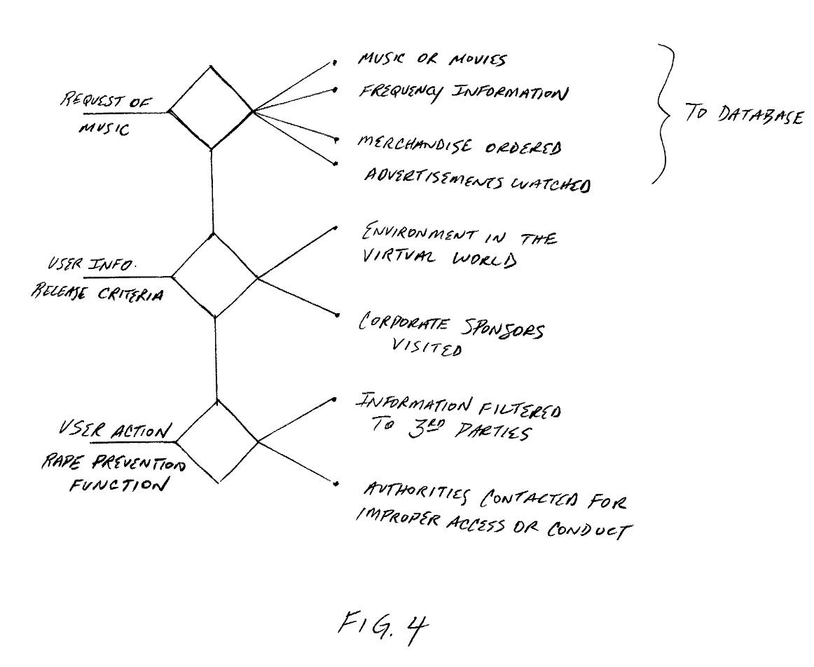

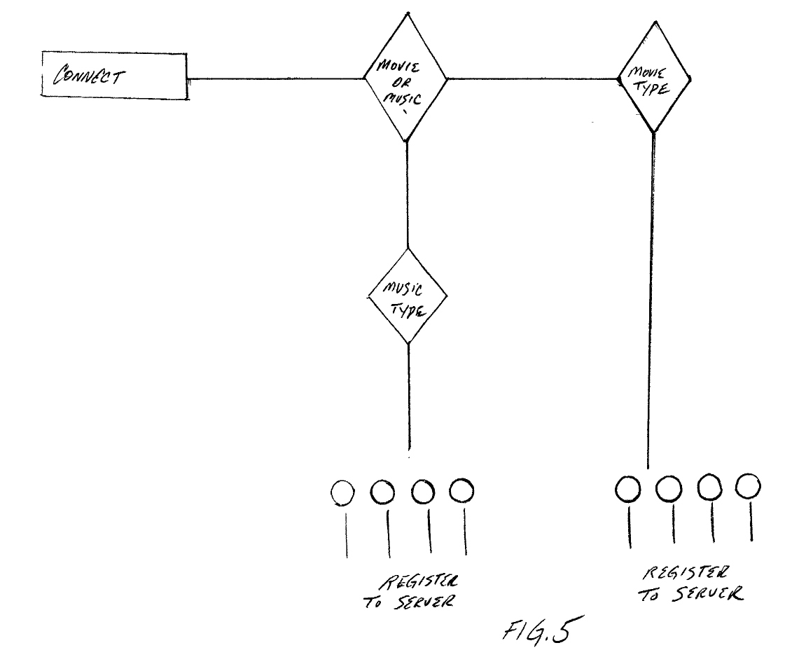

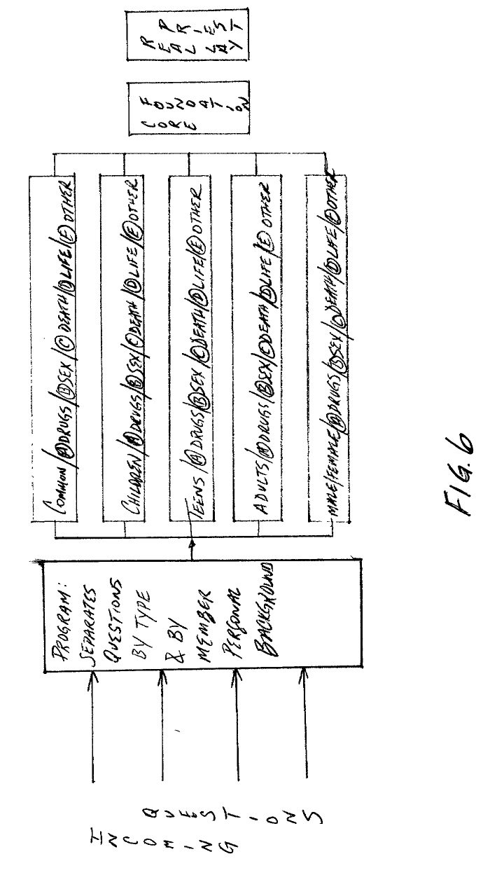

Referring to FIGS. 1-6, a method of Church controlled delivery of proprietary and public domain religious merchandise, sound recording, moving pictures and live virtual church activities by a supplier to subscribing members, primarily through computer terminals is disclosed. The supplier in some instances the Church itself and in other instances may be an e-merchant or existing physical Church sponsored store. The subscribing member is a pre-existing valid parishioner of the Church. Each subscribing member may only belong to one parish at a specific time. The prospective member must go to the corresponding rectory and apply in person to a bona fide church official. Usually the church requests from the parishioner the following key documents: (1) a Baptism certificate; (2) a First Communion certificate; (3) a Confirmation certificate; (4) an executed subscribing member agreement for use of the software; (5) an executed parental consent form for minors to use the systems; (6) credit card data sheet to enable the member to perform live transactions over the Web; and (7) Pastors approval letter. Once these requests are satisfied the subscribing member is permitted to purchase subscriber software which gives the member access to the Web based virtual reality Church. Delivery is accomplished either through delivered compact disks or through the Web in such a way that member access is monitored and controlled and the Church receives appropriate contributions from specific virtual Church activities, for articles and materials sold, and from advertisements that the supplier has delivered to the subscribing member.

A data warehouse of digitized music and video works is created and is either placed on a physical data storage medium, such as a compact disk, digital video disk and the like, or in a computer file accessible via the Web. The Church member becomes a subscribing member by complying with the appropriate archdioceses criteria and then obtaining from the Church or the supplier and installing a computer program in the form of subscriber software permitting and facilitating access to the data warehouse. The program may be incorporated into the data storage medium, which also contain the works. The subscriber pays a periodic subscription fee to the supplier and a portion of the payment is given to the Church as a contribution on behalf of the member. The pastor supplies the information of each individual subscribing member and his or her family to the supplier for use in marketing, security, and a credit or debit card number for use in member billing.

The Church and community assign permission and privilege to members in areas where minors are participating. While this system is a web based, the supplier and the Church have full access to and control of the content that is displayed to each minor. The system is monitored at all times by a virtual Angel that is programmed to understand profanity and moral behavior not consistent with the teachings of the Church.

For the law Df the spirit has freed you from the law of sin and death. We condemned sin in the Flesh, so that the righteous decree of the law might be fulfilled. (Roman 8:3,4) Paraphrased The virtual Angel will enlighten as Jesus spoke: “I am the light . . . Whoever follows me will not walk in darkness but will have the light of life.”(John 8:12) The virtual Angel is a product of artificial intelligence, since it would be impractical to provide a real person to monitor the individual actions of each and every subscribing member. Furthermore, the Church may assign virtual watchers who can only monitor but not interact with nor be able to know who the subscribing member children are, and upon detecting improper conduct they can notify the virtual Angel of the incident. Based on the severity of the misconduct the virtual Angel is able to first warn the members, explain to them the Christian way, and also to revoke privileges until the Internal Security Entity or Pastor and Parish CounciL review the incident.

To operate the system, the member inserts the compact disk or other data storage device containing the subscriber program into the appropriate driver of his or her computer device and visits the supplier web site. The member logs onto the system and selects and requests a certain work in the data warehouse from a list placed by supplier that reflects the available work and function the specific archdioceses has approved. Upon requesting certain works or functions, a member pays for play or purchase of the work by exchanging system credits earned as described below expressed in US dollars, which is considered the standard currency of the world, or by system automatic debiting of his or her credit card. Then, if playing of a work is selected, the work is played through the member computer terminal so that a musical work is audible to the member through the computer speakers or so that a moving picture or live video feed from the Church is visible to the member on the computer monitor and the audio portion is audible to the member through the computer speakers or the purchase of merchandise is delivered to the member in the form of an electronic document. The subscriber can stop play of the work at any moment and resume at any later time at the point where he or she stopped or from the beginning. The member may immediately select the same work again and pay the same or in some instances a reduced access fee for the second or subsequent playing of the work. If purchasing of the work is selected or the giving of a contribution for a specific electronic article or material is chosen the member request is downloaded or burned into a member CD.

All prices for playing or purchasing merchandise or works are preferably expressed in system credits. The prices of merchandise and works vary, just as prices of different merchandise in religious stores differ. In most instances, of course, the seasonal religious merchandise has a greater demand and thus commands a greater price, while less popular merchandise may be offered at a reduced or nominal charge, or free-of-charge. A member can purchase merchandise and, for works, also can have a work played through the delivery system, by paying the system credit price for purchase and burning the licensed work onto a CD.

The system optionally primes and validates the product and service quality of merchandise and works delivered to the members to ensure the highest level of TQM available, thereby promoting high levels of customer satisfaction. The member may purchase the merchandise or works from any religious article store that belongs to the Church and is affiliated to receive the proper credits into the billing system. In either case, the member may register the purchase of the merchandise or work using a unique encrypted number of the product with the system and any subsequent use of the merchandise through the system at no charge, since modern copyright law permits a purchaser of a copy of a merchandise item or work to play it at any time and as often as desired without further payment.

Members earn and accumulate system credits by agreeing and subsequently playing advertising campaigns offered by particular advertisers in a local-, archdioceses-, or worldwide-scope campaign. For example, a local real estate advertisement that is parish-specific Ls only visible to those members belonging to specific parishes in the local community with an archdiocese, while an advertisement that is dubbed worldwide such as a Coca Cola advertisement may be shown throughout the world in the native or preferred language of the member.

When the member purchases the system software, he or she joins a particular advertiser's ad-playing-for-system-credit plan. By way of example, company A may offer X credits for playing its particular advertising campaign, while company B may offer Y credits for a lesser or a more extensive campaign. The particular advertising campaigns offered to a member are limited to the advertising to which the subscriber archdioceses approves and to which the particular member is believed to be receptive and potentially interested in view of his or her profile maintained by the system. An elderly bachelor might receive investment firm advertising rather than child-care or feminine hygiene product advertising, for example. One such form of customized advertisement is of local parish functions such as the 4th of July barbecue or the Christmas party, which seem to fit within the established and individualized pattern of member access. This customized delivery of advertising campaigns to specific members increases the value of the campaigns to the advertisers, who in turn pay more for the system medium and format to the system suppliers.

The Church screens and approves all of the advertisements within the scope of the campaign. The Church's local council and pastor monitor approve and control local parish advertising, while the archbishop monitors, approves and controls archdioceses advertising and the Vatican pastoral counsel monitors, approves and controls worldwide advertisements. Furthermore, since intellectual property laws differ from one sovereign state to another, the supplier system has a legal board council that determines whether each advertisement follows local, state, federal and international laws.

Preferably, customized advertising separate from particular company campaigns is also offered. For example, such advertising directed to newly-released works and merchandise, as well as upcoming religious events, can be selectively-communicated to members based upon established member interests and/or the guidelines assigned by the local church pastoral council, thereby controlling the types of entertainment and services offered to the community. New release of merchandise and works, of course, as well as special Church events tickets, may be paid for with system credits. The system receives funding to sustain itself from advertiser revenue, from sales of merchandise and works burned onto CD's by members, and from member subscription fees.

A portion of the fees collected from members for playing works and selling merchandise is automatically placed in escrow to the Church as a contribution, or wired directly to the respective parishes. Alternatively, if the member contributes financially for a particular church activity or intention the money is sent directly to the corresponding bank account. Furthermore, if the members pay for playing of works and for merchandise with system credits, the fee due to the appropriate parish or intention is preferably paid from an advertising revenue fund, where the member compensated the system by listening to advertising. Alternatively, the fee can come from system revenue generated by participating in specific functions of the system, such as being the virtual kindergarten teacher for a CCD class of a specific parish for one day. In this manner, the Church receives all of its legally due contributions, and the letter and spirit of intellectual property law is upheld, thereby overcoming the drawbacks and limitations of existing delivery methods.

The supplier gains additional revenues through the delivery of advertising segments on the computer speakers or on the computer monitor of the users, as applicable, and these ads preferably run just prior to playing the work. This method of advertising delivery is analogous to the placement of corporate banners on the sidelines of FIFA World Cup soccer matches. The virtual priest and virtual angels alternatively may present advertising in pop-up form to members before specific system functions. Petitions are said during Church services and are found in the Bible, as Jesus instructed us to pray the “Lord's Prayer” (Matt 6:9-15). Church services also include announcements to give parishioners the opportunity to become involved in Church activities. Yet while Virtual Jesus is talking or during specific segments of a virtual Church activity when our faith believes that Jesus is present among us, no advertising is permitted as a symbol of respect and reverence. The Virtual Jesus in no way promotes the sale of merchandise, works or contributions to any intention except those approved by the Vatican pastoral council and then ratified by the local archdioceses, since different cultures may find it distasteful or out of context with the local Church mission. The virtual priest and virtual Jesus also are products of artificial intelligence. A priest is provided for hearing on-line reconciliations, and this priest is a real person ordained by the faith community.

The selection of advertisers, friends, merchandise, music and video works by each member is recorded and stored for marketing and security reasons and for automatic selection of future merchandise and products incentives, to better serve the customer consistent with the three TQM fundamentals of quality, product and service via a virtual priest or virtual angel. This information is used in part to customize the advertising displayed for the particular member during the playing and the show casing of future merchandise and works. Accessing and playing works helps the member to make decisions to buy compact disks or audio tapes derived from Church functions or digital video disks or video tapes of particular religious speciaL events or music videos. Such purchases are optionally offered through the supplier. In this way the system boosts rather than competes with the sales of merchandise and works, while drastically augmenting the cash flow of contributions to the Church.

The system also can be structured to detect and prevent fraud. The subscriber identification and selected work identification are mapped to the individual subscriber accessing the work. This form of access monitoring aids law enforcement in fraud investigations.

### First Preferred Embodiment of Apparatus for Performing Method

The physical make-up of the system is preferably as follows. Several inter-linked computers are provided having specialized functions, collectively referred to as a hive, and commercially named the Genesis Engine. The Genesis Engine consists of multiple clustered computers that operate in unison using Beowulf and Hoard technology to bui d a supercomputer that has shared SCSI disk space and memory and its own network packet protocol. Each node belongs to the collective and possesses its own business rules and membership to a computer network organization managerial hierarchy.

The system is made up of computers linked into a neural network, which continuously scans and gathers information from, understands and interacts with the environment. The system further consolidates its resources to automatically optimize certain parameters in real time, such as to minimize cost, to shunt functions from computers within the network operating at or near capacity and thus having small buffers to other computers having large buffers to maximize efficiency, and to continuously test and optimize selections offered to human users. The system further optimizes parameters and increases efficiency by running specialized computer programs belonging to the hive that exclusively read input from the environment and prime the information into lingua fraca output and the load balance of the tasks it assigns each node in the network to ensure that none of the components becomes cluttered and stops working at peak performance levels.

The system is provided within a virtual environment including several computers which are networked to each other to function as a single unit, including at least one parent computer synchronizing and delegating tasks among the several computers. In this manner, the unit scans ard gathers data from the virtual environment and processes and organizes the data into an implementable representation of the data. The unit preferably additionally includes at least one dedicated computer for performing a specific task, and at least one processing computer for providing processing power to the unit. Attached to the parent computer node are specialized function nodes that perform only specific high bandwidth tasks. The specialized function nodes distribute the primed lingua franca to the appropriate node according to specified business plans that take into account load balance, system integrity, work load in queue and available resources and members.

The Genesis Engine for the Church preferably includes four tiers of computer clusters: (1) a Software Tier in which each subscriber has its own member identification number which is unique and belongs to a specific parish; (2) an IP Tier in which several IP servers, preferably residing on a Sonnet ring, allocate resources to the subscribing member so that they can interact in the virtual environment; (3) a Billing and Control Tier through which the Genesis Engine validates each request, performs live billing and controls all of the interaction the members receive; and (4) an Internal TQM and Security Tier which regulates the data content delivered according to the member agreement and local, state, national and international law by the supplier in real time to improve the quality of products and services to the members; and (5) a summit tier through which a virtual representation of God is created which includes a database containing data about world history, dilemmas, customs, contemporary beliefs and dogma. The system further regulates and gives access to law enforcement agencies and to internal Church security services to monitor, manage and control accesses and privileges of members to bring law and order where the Web has created anarchy and chaos.

For God made the light, and he saw how good it was and then separated the light from the darkness. (Geneses 1:3) Paraphrased.

The production Genesis Engine Billing and Control Tiers are locally, regionally and geographically distributed to maximize bandwidth and better adapt to the needs of the members of the Church. Each IF, server belongs to specific archdioceses, and preferably hosts all of its members. Blocks of members receive a live video from a virtual priest and/or individualized selections from a virtual angel, such as St. Michael and furthermore specific and approved interaction with the virtual interpretation of our Lord Jesus Christ (hereinafter referred to as Virtual Jesus). The Billing and Control Tier is also responsible for providing on demand resources to each subscribing member.

As indicated above, Virtual Jesus is a product of artificial intelligence, and it is a group of linked computers that are programmed by certain fundamental truths based on the teachings of the church, and the dogma followed by the parish members. The Virtual Jesus is responsible for reprogramming the way that virtual angels interact with subscribing members.

The first objective of the Virtual Jesus is to identify the subscribing member by personal information, including: (1) age; (2) gender; (3) maturity level; (4) spiritual level; (5) past interactive knowledge; (6) educational knowledge; and (7) personality while interacting with other users.

The second objective is to transform the teaching of the Church to modern times by having access to the following information and acceptable notion of specific cultures and civilizations: (1) religious teachings of the Church; (2) world history data; (3) theological answers to specific questions; (4) scientific knowledge; (5) appreciation for the effects of technology towards Man; (6) psychological patterns of behavior based on specific profiles; and (7) access to human priests, teachers, parents and friends of the subscribing members that might help elucidate in a more personal way the answer to a the question.

The third objective is to have access to the specialized computer for specific subject matter that has audio, documents and video that might answer the question to the subscribing member. For example a child asks, concerning the miracle of the 4,000, why the Bible says that 4,000 men were fed. The system would explain that when the Bible was written the word “men” included women and children. Then the system would search for video feeds of movies of Jesus and based on the personal profile broadcast the appropriate video feed showing the Lord Jesus Christ performing the miracle of the multiplication of food and then showing thousands of families assembled partaking with the Lord.

Virtual Jesus or the virtual angels automatically provide answers to questions that are considered highly reliable. Otherwise, the question is broken down by category, age group, maturity, knowlecge and understanding level of the individual. For example questions can be broken down by the type of question and corresponding node that specializes in the particular subject matter. Once the specific node is identified the artificial intelligence converts the question into modern semantics structure and finds a present world reality question. For example, abortion questions are not covered in the four Gospels, notwithstanding it is a common modern day problem. Subsequently, the Virtual Jesus searches for the best answer to the question if the answer is available or asks a human priest or a lay minister to participate in the response. The answer is then translated into the user language, level of understanding, and acceptable subject matter. If the Virtual Jesus does not find a reliable answer, but identifies an available priest, the system requests the priest to participate in the answer and appears for the subscribing member to help answer the question. The subscribing member and priest remain anonymous to each other.

The operations of the production Genesis Engine Internal TQM and Security Tiers are locally and worldwide geographically distributed. Locally these operate to assure that local and national laws are observed within the geographical boundaries of a specific archdioceses. The Vatican also has its own internal security to assure that the system is being monitored and controlled as a whole. This Tier also has a link to law enforcement agencies to help the agencies in the prevention and detection of crime. Notwithstanding, the ultimate police force is the parish community that acts as a family and educates each member to follow the teachings of the Church. When the Law of God differs from the law of man, the Law of God always prevails. For Jesus says:

“I am the good Shepard.” (John 10:14) “And there will be one flock, one Shepard.” (John 10:16) This is reflected in the member agreement. No one is forced to join the Church, but once one voluntarily accepts God's call, one must adhere to the teachings of the Church as an obligation of each member of the Church.

Each subscribing member receives access and operational programming on a set of CD's designating a specific category of merchandise and religious works and predefined advertisements customized to the particular subscribing member. These programs create a virtual reality representation of a church building, religious site or school so that the member is able to interact in the virtual world. The programs further have their own artificial intelligence and possess the member credit card information in an encrypted format so that the subscribing member can make the request on the fly. When a credit card number is registered, the subscribing member places a specific password to determine authenticity.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims hereafter appended.

I claim:

1. A computer network system within a virtual environment for delivery of religious works of authorship to subscribing members of a church in exchange for payment, comprising:
a plurality of networks representing individual faith communities and their members, each said network comprising a plurality of computers which are networked to each other in a hierarchy to function as a single unit, said hierarchy comprising a first tier including at least one parent computer performing subscribing member billing tasks and synchronizing and delegating tasks among said plurality of computers, a second tier including at least one server computer allocating network resources to maximize bandwidth and direct selected works to subscribing members requesting the works; and a third tier including a plurality of subscribing member devices, each subscribing member device having system programming containing individual subscribing member identification means and work accessing means.

2. The system of claim 1, wherein said work accessing means comprises one of a virtual reality representation of a site and a live session, and an interactive accessing procedure.

3. The system of claim 2, wherein said site is a house of worship.

4. The system of claim 2, wherein said interactive accessing procedure comprises interacting with a virtual representation of Our Lord Jesus Christ.

5. The system of claim 2, wherein said interactive accessing procedure comprises interacting with a virtual priest.

6. The system of claim 2, wherein said interactive accessing procedure comprises performing a virtual reconciliation with a human priest.

7. The system of claim 2, wherein said interactive accessing procedure comprises interacting with a virtual religious person.

8. The system of claim 1, wherein said system programming within individual subscribing member devices comprises the subscribing member invoice delivery instructions.

9. The system of claim 8, wherein said invoice delivery instructions comprise the subscribing member credit card number for making payment for accessed works and pledged contributions.

10. The system of claim 1, wherein said system programming comprises work encrypting means preventing unauthorized access to the works.

11. The system of claim 10, additionally comprising decrypting means for decrypting of works for accessing of the works by subscribing members who have paid to purchase the given works.

12. The system of claim 1, further comprising a real-time login procedure, and request and reply mechanisms for validating each activity and transaction.

13. The system of claim 1, further comprising an answer database containing data in the form of answers to questions, and means for retrieving answers from said answer database in response to questions posed by subscribing members, and means for continually updating and altering said answer database.

14. The system of claim 1, further comprising a fifth tier having means for creating a virtual representation of God including a database containing data about world history, dilemmas and dogma.

15. The system of claim 14, wherein said virtual representation of God is generated by a group of linked computers that are programmed by certain fundamental truths based on the teaching of the church, and the dogma followed by the faith community members, the virtual representation of God being responsible for reprogramming the way the virtual angels interact with subscribing members, said virtual representation of God identifying each given subscribing member by personal information, transforming the teachings of the Church to modern times, and having access to a computer database for audio, documents and video useful in answering questions to the subscribing members.

16. A method of providing accessing works of authorship through a computer network system within a virtual environment for subscribing members in exchange for payment, said computer network system comprising a plurality of networks representing individual faith communities and their members, each said network comprising a plurality of computers which are networked to each other to function as a single unit, said plurality of computers including at least one parent computer synchronizing and delegating tasks among said plurality of computers, at least one server computer allocating network resources to maximize bandwidth and direct selected works to subscribing members requesting the works and a data warehouse; and a plurality of subscribing member computers, each subscribing member computer having system programming containing individual subscribing member identification means and work accessing means; the method comprising the steps of:
loading system programming for loading into an individual subscribing member computer;
logging onto the system and thereby entering the world wide web;
requesting a certain work from the system for use on the individual subscribing member computer;
making payment to the system for use of the certain work through the system;
and directing payment for the use of the certain work to the faith community.

17. The method of claim 16, comprising the additional step of creating a personal profile of each individual subscribing member and enhancing the profile with an on-going record of particular works and categories of works accessed by each individual subscribing member and of member associations with other members.

18. The method of claim 17, comprising the additional step of:
providing system credits for subscribing members to earn and pay for use of works.

19. The method of claim 18, comprising the additional steps of providing means for making the payment for use of works in system credits; and the individual subscribing member earning system credits and paying for use of a work in system credits.

20. The method of claim 19, comprising the additional step of providing means for earning system credits by electing to receive and then playing advertising on the individual subscribing member computer.

21. The method of claim 20, wherein the advertising comprises advertising selected for the particular subscribing member according to the contents of the profile of the individual subscribing member.

22. The method of claim 17, comprising the additional step of providing a virtual reality site for accessing works including a virtual faith community containing a representation of an interactive virtual religion member, said interactive virtual religion member which plays works selected by the individual subscribing member.

23. The method of claim 17, comprising the additional step of providing a means for monitoring persons to monitor the conduct of a subscribing member logged onto the system to comply with the teachings of the faith community and for these monitoring members to notify a system representative of any breach of conduct by the monitored subscribing member.

24. The method of claim 23, wherein said system representative is a product of artificial intelligence in the form of a virtual Angel.

25. The system of claim 24, wherein said system representative is a member of a local law enforcement agency for deterring crime in the form of a virtual police officer.

26. The system of claim 25, wherein said system modifies and reviews the subject matter monitored by the virtual Angel and the virtual police officer.
